(19) United States
(12) Patent Application Publication
(10) Pub. No.: US 2005/0254374 A1
(43) Pub. Date: Nov. 17, 2005

(54) Method for performing fast-forward function in audio stream

(76) Inventor: Shih-Sheng Lin, Taipei (TW)

Correspondence Address: BIRCH STEWART KOLASCH & BIRCH, PO BOX 747, FALLS CHURCH, VA, 22040-0747, US

(21) Appl. No.: 10/933,399

(22) Filed: Sep. 3, 2004

(30) Foreign Application Priority Data
May 11, 2004 (TW) 093113174

(51) Int. Cl. G11B 5/09

(52) U.S. Cl. 369/47.36; 369/53.25; 369/47.1

(57) ABSTRACT

A fast-forward method uses a time-scaling algorithm to perform a fast forward function. It uses the range restriction and slope calculation of an inter-coefficient algorithm to perform audio compression and improve the sound quality. The present invention applies the time-scaling algorithm on the data unit of the audio data stream to compress several data units into a data unit according to a required compression ratio. Thereby, a good sound quality can be maintained.

### BACKGROUND OF THE INVENTION

1. Field of the Invention

The present invention is directed to a method for performing a fast-forward function in an audio stream, and more particularly, to a method using a time-scaling algorithm to perform the fast forward function. The present invention can improve the sound quality via employing the range restriction and slope computation of the time-scaling algorithm.

2. Description of Related Art

In general, when a user is using an audio medium, such as a compact disc (CD), a video compact disc (VCD), a digital versatile disc (DVD) or a tape, he may need to fast-forward or reverse the audio stream, especially while listening or watching a multimedia file. If he needs to reach a predetermined point speedily and then play with a slow speed, the fast/slow forward and or fast/slow reverse will be necessary. Hence, some methods to fulfill the requirements mentioned above have developed in the prior art, such as, for example, the sampling-frequency method and the time-scaling method.

FIG. 1 can be used to explain the concept of the conventional time-scaling method. Therein, an input stream M is divided into several windows, such as first window 11, second window 12, third window 13 and so forth. The size of the windows is a minimum unit of the input stream M. Under a predetermined compression ration, the windows of the input stream M are compressed to overlap with each other to form the output stream N. As shown in the figure, the first window 11 and the second window 12 have an overlap portion P1, and the second window 12 and the third window 13 have an overlap portion P2. By using this compression process, the input stream can be compressed and fast-forwarded.

Reference is made to FIGS. 2A-2F, which illustrate another conventional time-scaling method. FIGS. 2A-2F are schematic diagrams of sound waveforms versus time. FIG. 2A shows a minimum wavelength Lmin and a maximum wavelength Lmax. Via using a similarity detection process to increase the minimum wavelength Lmin to the maximum wavelength Lmax, a basic period Lp is found as shown in FIG. 2B. According to this basic period Lp, the original sound wave can be divided into the first waveform A and the second waveform B as shown in FIG. 2C. As shown in the figure, the first waveform A has a descending slope (FIG. 2D) and the second waveform B has an ascending slope (FIG. 2E). By combining the first waveform A and the second waveform B to form a combined waveform (A+B) to replace the original waveforms A, B, the result of the conventional time-scaling method is obtained.

Reference is made to FIG. 3A, which is a schematic diagram of a data stream in accordance with a conventional sample frequency method disclosed in U.S. Pat. No. 6,424,789. This conventional method changes the fast/slow forward sample process according to the video content. Only the sample method for the audio data is discussed here. As shown in the figure, the audio stream 30 has two shots, including the first shot 31 and the second shot 32. Each of the shots further includes multiple frames, such as the frames F1, F2, F3, F4 . . . Fn of the first shot 31 and the frames F1, F2, F3, F4 . . . . Fm of the second shot 32. If the audio data are played at a slow speed, frames formed according to the adjacent frames must be inserted or additional frames must be duplicated to lengthen the displayed data stream. If the audio data is played at a fast speed, frames selected according to a selection criterion (not detailed here) must be discarded to shorten the data stream. As shown in the figure, the frames F2, F4 of the first shot 31 are discarded and the frames F2, Fm′ of the second shot 32 are discarded. By using this method, the fast/slow forward or reverse function can be provided.

FIG. 3B is a flowchart for the conventional method illustrated in FIG. 3A. When starting to play the audio data (step 301), the audio equipment will receive the incoming audio stream from the playing source (step 302). The processor of the equipment, such as digital signal processor (DSP), will perform segmentation of the incoming audio stream into a plurality of shots (step 303). A used-selected speed change effect will be determined according to a user's selection (step 304). The audio shot will be classified according to the activity level selected by the user and divided into multiple different frames (step 305). An appropriate sampling algorithm will be applied to discard or duplicate the frames to perform the fast/slow playing function (step 306) and then determine if the last shot is processed (step 307). If no, some shots still remain and the next shot is processed (step 308). Then, the audio shot will be classified according to the activity level selected by the user and processed by following steps (step 305). If the last shot is processed, the frames of the shots will be reassembled to form a modified audio stream (step 309) and this modified stream is the needed for the user to play the audio stream with a fast or slow speed.

As discussed above, the first embodiment of the prior art uses time-scale compression technology to perform the fast forward or reverse function. However, finding the similarity point requires many calculations. Directly using the fixed point will make the audio stream discontinuous and the noises of a shock wave will be induced, especially when multiple tones are played at a fast speed.

As for the second embodiment, the method using sampling frequency will induce the frequency conversion to make the sound abnormal. The sound usually becomes shrill or has higher frequencies.

Accordingly, as discussed above, the prior art still has some drawbacks that could be improved. The present invention aims to resolve the drawbacks in the prior art.

### SUMMARY OF THE INVENTION

An objective of the present invention is to remove the frequency conversion and noises of a shock wave occurring in the prior art and hence provide a time-scaling algorithm developed from the time-scaling technology to perform a fast-forward function. Via using the range restriction and slope calculation of a time-scaling algorithm, the present invention can improve the fast-forward sound quality.

Therein, the method of the present invention uses an inter-coefficient algorithm developed from the time-scaling technology to compress an audio stream. The method stores a plurality of data units in at least a buffer; sets a plurality of indices in the buffer; sets a reference point, which is an alignment point used in the inter-coefficient algorithm; uses an address of the alignment point to perform the inter-coefficient algorithm to obtain a compressed data unit; and moves one of the indices of the buffer to a next audio address. An audio compression is thereby finished for performing the fast-forward function.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram used to illustrate a concept of a conventional time-scaling method;

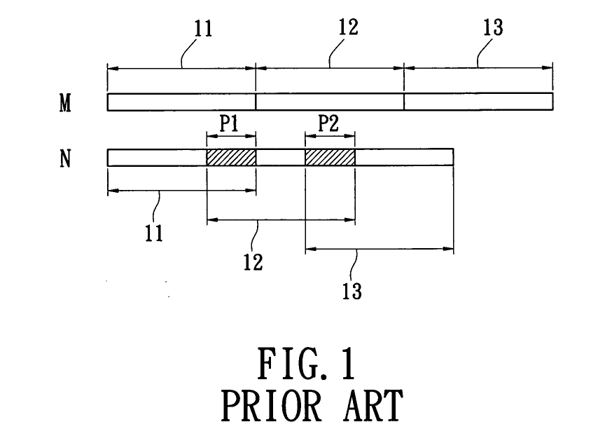

FIGS. 2A-2F are schematic diagrams of waveforms versus time;

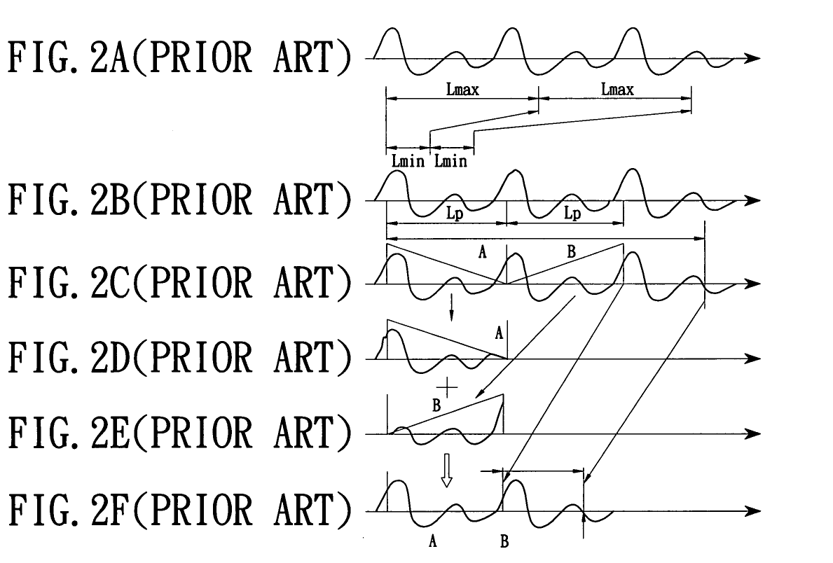

FIG. 3A is a schematic diagram of a data stream in accordance with a conventional sample frequency method;

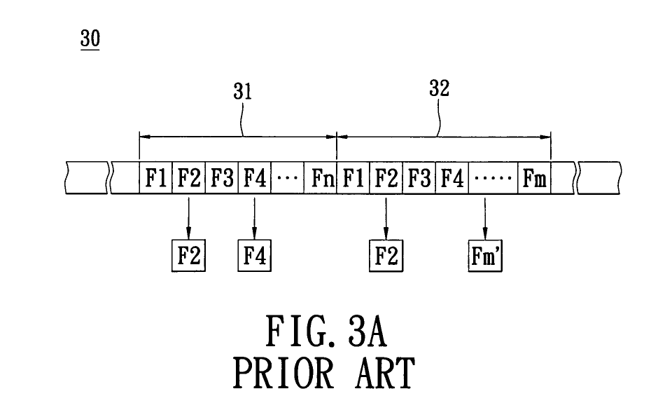

FIG. 3B is a flowchart for the conventional frequency sampling method;

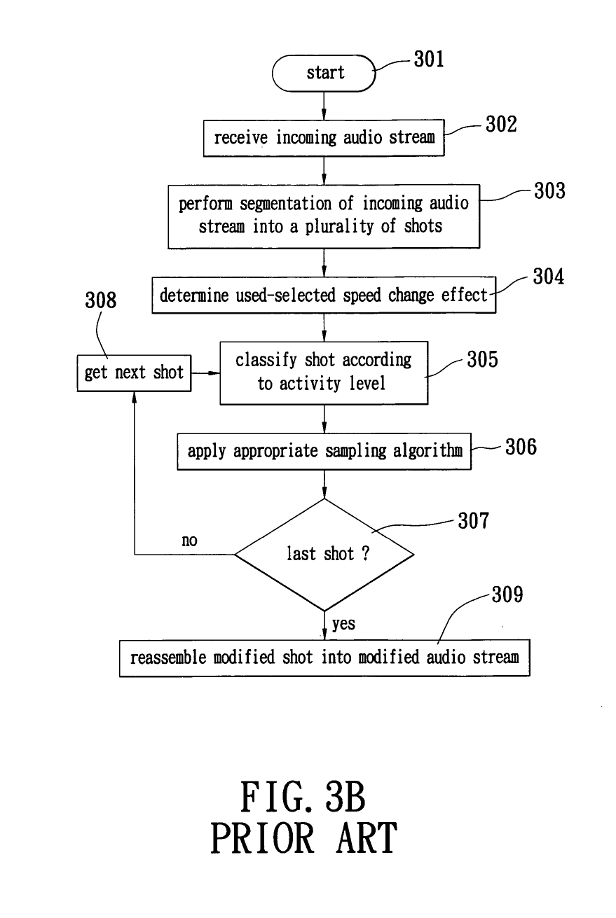

FIGS. 4A-4C are schematic diagrams of a method using a time-scaling algorithm to perform a fast-forward function in accordance with the present invention; and

FIG. 5 is a flowchart of a method for performing a fast-forward function in accordance with the present invention.

### DETAILED DESCRIPTION OF PREFERRED EMBODIMENTS

The present invention is a method for performing a fast-forward function. In order to remove the drawbacks of the conventional method using time scaling or frequency sampling, such as frequency conversion or noise of a shock wave, the present invention provides a method to improve the conventional method using a time scaling algorithm to perform the fast-forward function. The present invention uses range restriction and slope calculations to improve the sound quality when a fast-forward function is performed.

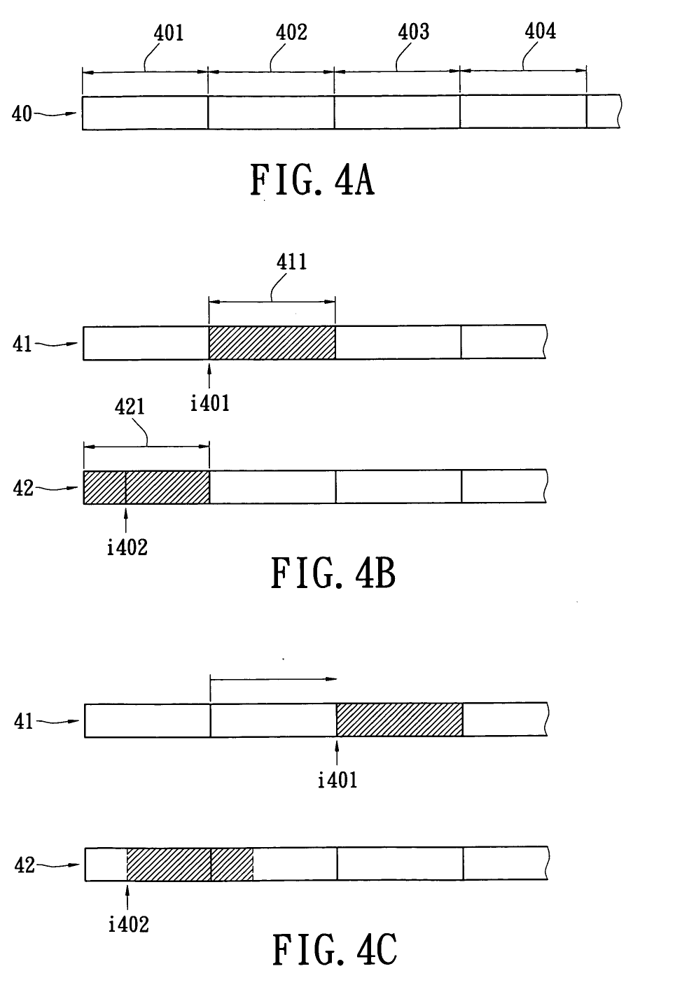

Reference is made to FIGS. 4A-4C, which are schematic diagrams for illustrating the method using a time-scaling algorithm to perform the fast-forward function in accordance with the present invention.

FIG. 4A represents a data stream 40, including data units 401-404. Each of the data units includes multiple minimum units of the audio data, i.e. audio samples. The present invention will perform a time-scaling algorithm to compress multiple data units into a single data unit according to a predetermined compression ratio, such as compressing two data units into one for two-fold fast-forward or four into one for four-fold fast-forward. By using this way, the present invention can still provide a good sound quality.

Reference is made to FIG. 4B, which is an embodiment of a two-fold fast-forward. Therein, a first buffer 41 and a second buffer 42 are located in a memory. Every two data units of the data stream 40 will be stored in one of the buffers. For example, the data units 401 and 402 will be stored in the memory block 421 of the second buffer 42, i.e. buffer 1 in formula 1; the data units 403 and 404 will be stored in the memory block 411 of the first buffer 41, i.e. buffer 2 in formula 1. In the case of two-fold fast-forward, the length of the memory blocks 411 and 421 is the same as the length of two data units. In addition, some indices are defined in the buffers, such as the index i401 of the first buffer 41 and the index i402 of the second buffer 42. The indices are used to indicate the samples in the data units.

In order to remove the phenomenon of frequency conversion or the noise of shock wave, the method of the present invention will search for an alignment point of similar waveforms before compression. This alignment point is an initial point for the inter-coefficient algorithm. Reference is made to formula 1, below.
Temp[i]+=Buffer1[index1+1]×Buffer2[index2+j]

In this formula, Buffer1[ ] is an address function of the first buffer 41 and Buffer2 is an address function of the second buffer 42. Therein, index1+i represents the addresses of the samples of the data units inside the first buffer 41 and index2+j represents the addresses of the samples of the data units inside the second buffer 42.

In the inter-coefficient algorithm, the values of the data units (401, 402, 403, 404) will be substituted into formula 1 to find a most similar waveform. Taking FIG. 4B for example, Buffer1 refers to data units 401 and 402 and Buffer2 refers to data units 403 and 404. After substitution, the maximum temp[i] can be found. This i point is the most similar point of these two buffers and so-called alignment point. Then, the alignment point will be substituted into the formula 2 as below to obtain sound data to replace the original data.
buffer1[alignment+i]=(buffer2[i]>i+buffer1[alignment+i]×unit−buffer1[alignment+i]×i)/unit, i=0−unit

Therein, Buffer1[ ] is the address function of the first buffer 41 and Buffer2 is the address function of the second buffer 42. “alignment+i” represents the alignment address of the data units of the first buffer and variable i represents the initial address of the data unit of the second buffer.

Since finding the inter-coefficient requires a large number of multiplications, the present invention can find the similar point by searching the slope and numerical region to lower the calculation complexity. For example, the present invention will set a point inside the data units 403 and 404 as a comparison point and an initial search point i401 inside the data units 401 and 402. Then, the present invention will define a range A and find whether the same slope and numerical difference are located in the range A for obtaining the optimum alignment point. The present invention will search for the optimum alignment point from the initial point to the index i402. When the optimum alignment point is found, it will be substituted into formula 2 to obtain new sound data. By using this method, the calculation for finding the most similar waveform can be reduced considerably.

FIG. 4C shows that the index i401 is moved to the next data unit and the alignment point i402 inside the second buffer 42 obtained by using formula 2 is used as the initial point for the next compression operation.

Finally, the present invention will output the data inside the second buffer to provide the fast-forward sound signals.

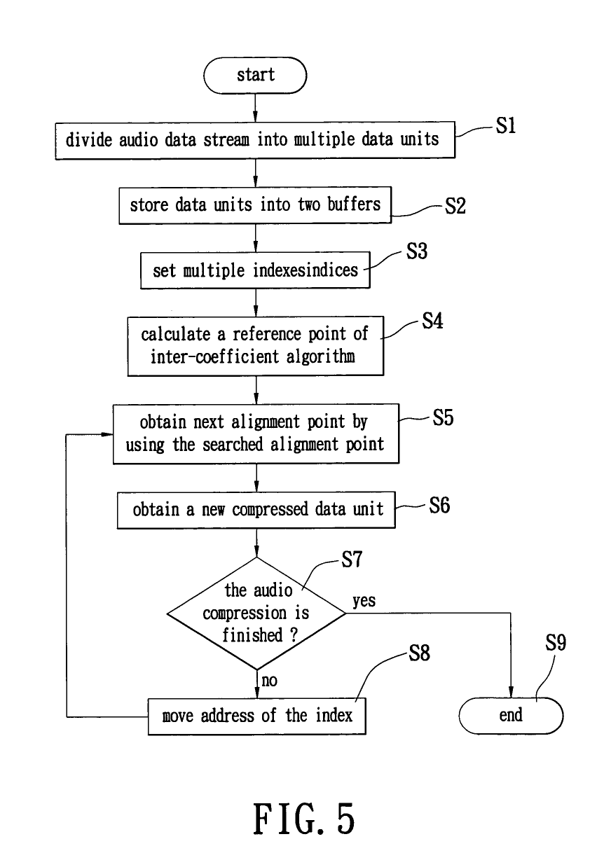

Reference is made to FIG. 5, which is a flowchart of the method for performing a fast-forward function in accordance with the present invention.

The method includes:

step S1: dividing the audio data stream into multiple data units according to the requirements;
step S2: storing the data units into at least a buffer according to the required compression ratio or fast-forward speed; for example, as shown in FIG. 4A, the present invention stores the data units into the first buffer 41 and second buffer 42 two by two for two-fold fast-forward;
step S3: setting multiple indices in the buffers to indicate the audio address; for example, as shown in FIG. 4, the first buffer 41 has the first index i401 and the second buffer 42 has the second index i402;
step S4: calculating a reference point via using the samples of the data units marked inside the buffers to obtain the initial point of the inter-coefficient algorithm;
step S5: searching for an optimum alignment value from the initial point by using the inter-coefficient algorithm, where the initial point is an alignment point of the inter-coefficient algorithm and the optimum alignment value will serve as an alignment point of the next calculation (as description for formula 2) and the first alignment point can be obtained according to experience; in this step, every sample of the data unit will be substituted into the formula 2 in order to obtain the next alignment point by summation;
step 6: performing the inter-coefficient algorithm from the alignment address; by using the indices, a new compressed data unit can be obtained in the buffer and output to form the fast-forward audio signals;
step 7: determining-whether the audio compression is finished;
step 8: if the audio compression is not finished, the first index of the first buffer will be removed to the next address for another compression operation according to the compression ratio determined in step S2 and steps S5-S7 described above will be repeated to finish the audio compress so as to perform the fast-forward function;
step 9: if the audio compression is finished, this method ends.

In accordance with the steps described above, the data units will be stored in the buffers respectively according to the compression ratio or fast-forward speed. If two data units are read in and then one new data unit is read out from the buffers, a two-fold fast-forward will be performed. If four data units are read in and then one new data unit is read out from the buffers, a four-fold fast-forward will be performed.

Summing up, the present invention aims to remove the frequency conversion and noise of a shock wave occurring in the prior art and hence provides a time-scaling algorithm developed from the time-scaling technology. Thus, the present invention provides an inter-coefficient algorithm to perform audio compression by using the range restriction and slope computation. Thereby, the sound quality can be improved, the power consumed in the compression calculation can be reduced, and the necessary memory can be less.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. A method for performing a fast-forward function, which uses an inter-coefficient algorithm developed from a time-scaling technology to compress an audio data stream, the method comprising:
storing a plurality of data units in at least a buffer;
setting a plurality of indices in the buffer;
setting a reference point, wherein the reference point is an alignment point used in the inter-coefficient algorithm;
using an address of the alignment point to perform the inter-coefficient algorithm to obtain a compressed data unit; and
moving one of the indices of the buffer to a next audio address;
whereby an audio compression is finished for performing the fast-forward function.

2. The method as claimed in claim 1 further comprising:
dividing the audio data stream into the data units.

3. The method as claimed in claim 1, wherein the data units include a plurality of samples.

4. The method as claimed in claim 1, wherein the step of storing the data units into the buffer is performed according to a required compression ratio or a fast-forward speed.

5. The method as claimed in claim 1, wherein the step of setting the reference point is performed via calculating from an initial point and the reference point serves as another alignment point for a next calculation.

6. A method for performing a fast-forward function, which uses an inter-coefficient algorithm developed from a time-scaling technology to compress an audio data stream, the method comprising:
dividing the audio data stream into a plurality of data units;
storing the data units in a first buffer and a second buffer, respectively;
setting a plurality of indices in the first buffer and the second buffer;
setting a reference point, wherein the reference point is an alignment point used in the inter-coefficient algorithm;
using an address of the alignment point to perform the inter-coefficient algorithm to obtain a compressed data unit; and
moving one of the indices of the buffer to a next audio address;
whereby an audio compression is finished for performing the fast-forward function.

7. The method as claimed in claim 6, wherein the data units include a plurality of samples.

8. The method as claimed in claim 6, wherein the step of storing the data units in the first and second buffers is performed according to a required compression ratio or a fast-forward speed.

9. The method as claimed in claim 6, wherein the alignment point is obtained by using a following formula:
temp[i]+=Buffer1[index1+1]×Buffer2[index2+j];
wherein Buffer1[ ] is an address function of the first buffer, Buffer2 is an address function of the second buffer, index1+i represents addresses of the samples of the data units inside the first buffer and index2+j represents addresses of the samples of the data units inside the second buffer.

10. The method as claimed in claim 6, wherein the inter-coefficient algorithm is performed by using a following formula:
buffer1[aligment+i]=(buffer2[i]×i+buffer1[alignment+i]×unit−buffer1[alignment+i]×i)/unit;
wherein Buffer1[ ] is an address function of the first buffer, Buffer2 is an address function of the second buffer, alignment+i represents an alignment address of the data units of the first buffer and variable i represents an initial address of the data unit of the second buffer.
